(19) United States
(12) Patent Application Publication
(10) Pub. No.: US 2005/0231478 A1
(43) Pub. Date: Oct. 20, 2005

(54) Computer mouse cover

(76) Inventor: Tammy L. Keck, Avon, IN (US)

Correspondence Address: Schwartz Law Firm, P.C.;Suite 530, SouthPark Towers, 6100 Fairview Road, Charlotte, NC, 28210, US

(21) Appl. No.: 10/827,182

(22) Filed: Apr. 19, 2004

(51) Int. Cl. G09G 5/08

(52) U.S. Cl. 345/163

(57) ABSTRACT

A cover is provided for use on a computer mouse having an outer shell and a mouse ball projecting from the shell. The cover has top and bottom panels joined together along respective sides. The panels cooperate to form an end opening adapted for receiving the computer mouse inside the cover. The bottom panel defines a ball hole for accommodating passage of the mouse ball through the cover and onto a supporting surface.

### TECHNICAL FIELD AND BACKGROUND OF THE INVENTION

This invention relates to a computer mouse cover. The invention is applicable for use with conventional computer mouses, and serves to maintain the mouse in a clean and functional condition while promoting comfortable use and handling.

A dirty computer mouse is not just a cosmetic concern. Dirt and debris can infiltrate the outer shell of the mouse and cause mouse movements to be jumpy and imprecise. Users are advised to clean their hands before using the mouse, and to watch out for grease, hand lotion, dust balls, food crumbs, eraser residue, and the like. In some environments, it is recommended that mouses be periodically open up for deep internal cleaning. It is also recommended that users disinfect their computer station including the mouse on a fairly regular basis. The office desk has been referred to as a cafeteria for germs.

In addition to issues of cleanliness, the computer mouse can also become slippery and difficult to control with a sweaty palm and fingers. This commonly occurs when using a computer while nervous, playing exciting interactive games, or when just hot. Many current mouses and keyboards have a slightly textured surface, presumably to reduce this problem. Despite this design, the computer mouse often remains moist and uncomfortable to handle under a sweaty hand.

### SUMMARY OF INVENTION

Therefore, it is an object of the invention to provide a mouse cover adapted for use with conventional computer mouses.

It is another object of the invention to provide a mouse cover which can be conveniently removed and laundered, thereby reducing the spread of germs between common users of the computer mouse.

It is another object of the invention to provide a mouse cover which promotes comfortable handling and use of the computer mouse.

It is another object of the invention to provide a mouse cover which is designed to quickly move moisture away from the hand of a user.

It is another object of the invention to provide a mouse cover which does not interfere with normal use and operation of the computer mouse.

It is another object of the invention to provide a computer mouse cover which is inexpensive and disposable.

These and other objects of the present invention are achieved in the preferred embodiments disclosed below by providing a cover for use on a computer mouse having an outer shell and a mouse ball projecting from the shell. The cover has top and bottom panels joined together along respective sides. The panels cooperate to form an end opening adapted for receiving the computer mouse inside the cover. The bottom panel defines a ball hole for accommodating passage of the mouse ball through the cover and onto a supporting surface.

The term “joined” is defined broadly herein to mean either two formerly separate panels connected together, or integrally formed by, for example, folding over a single panel to define a side edge.

According to another preferred embodiment, means are provided for substantially closing the end opening, such that the computer mouse is substantially encased within the cover.

According to another preferred embodiment, first and second closure flaps are formed with respective top and bottom panels at the end opening.

According to another preferred embodiment, the means for closing includes first and second complementary fasteners located on respective closure flaps.

Preferably, the first and second fasteners are respective hook and loop fastener strips extending laterally at the end opening from one side of the cover to the other.

According to another preferred embodiment, the top panel defines a wheel hole adapted for accommodating access to a scroll wheel located on the computer mouse.

According to another preferred embodiment, the top and bottom panels are constructed of a fabric comprising fibers selected from the group consisting of polyester, cotton, and nylon.

In another embodiment, the invention is a cover for use on a computer mouse having an outer shell, a mouse ball projecting from a bottom of the shell, and a scroll wheel projecting from a top of the shell for access by a user. The cover has top and bottom panels joined together along respective sides. The panels cooperate to form an end opening adapted for receiving the computer mouse inside the cover. The top and bottom panels further include means for substantially closing the end opening. The top panel defines a wheel hole for accommodating access to the scroll wheel through the cover. The bottom panel defines a ball hole for accommodating passage of the mouse ball through the cover and onto a supporting surface. The top and bottom panels are constructed of a fabric adapted for moving moisture away from a hand of the user.

Preferably, the fabric includes hydrophillic fibers.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is an environmental view of the computer mouse cover according to one preferred embodiment of the present invention, and showing the cover in place over the computer mouse;

FIG. 2 is a view of the mouse cover with the closure flaps opened prior to receiving the computer mouse inside the cover;

FIG. 3 is a bottom view of the cover as applied to the computer mouse;

FIG. 4 is a top perspective view of the mouse cover according to a second preferred embodiment of the present invention, and showing the cover applied to a standard computer mouse including a scroll wheel; and

FIG. 5 is a bottom view of the cover shown in FIG. 4 as applied to the computer mouse.

### DESCRIPTION OF THE PREFERRED EMBODIMENT AND BEST MODE

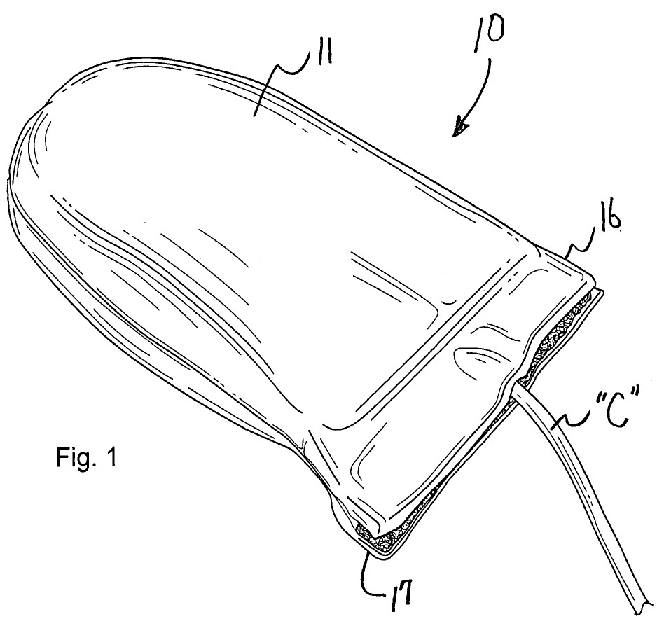

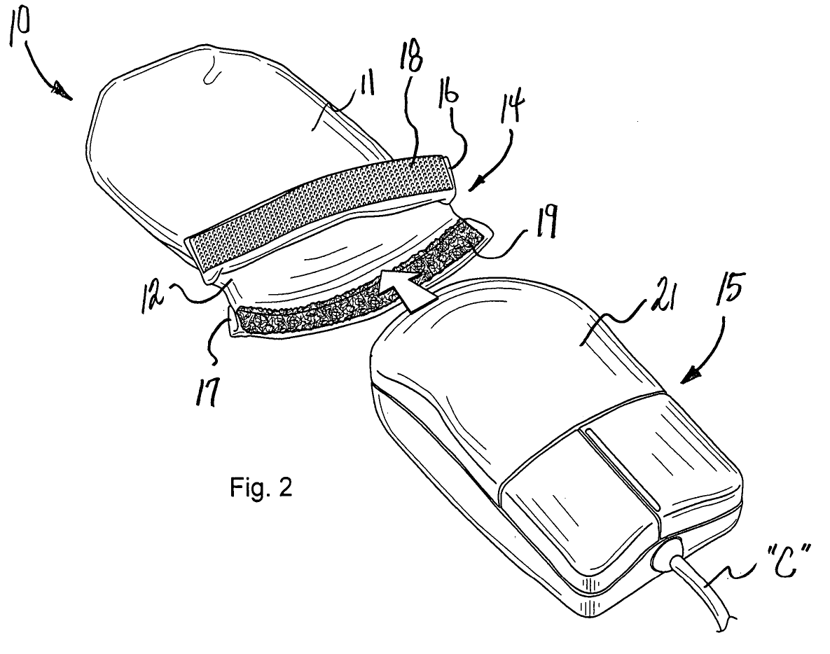

Referring now specifically to the drawings, a computer mouse cover according to the present invention is illustrated in FIG. 1, and shown generally at reference numeral 10. The mouse cover 10 is constructed of opposing panels 11 and 12 joined together along respective sides and forming an end opening 14 through which the computer mouse 15 (See FIG. 2) is inserted. First and second closure flaps 16 and 17 are formed with the panels 11, 12 at the end opening 14, and have mating hook and loop fastener strips 18 and 19 which cooperate to close the end opening 14 and substantially encase the mouse 15 inside the cover 10. Each fastener strip 18, 19 extends from one side of the cover 10 to the other. In other embodiments, the closure flaps 16, 17 may be releasably closed by snaps, buttons, an elastic band, ties, release adhesive, or the like. The hook and loop fastener strips 18, 19 shown in FIG. 2 allow substantial closure of the entire end opening 14 while accommodating the mouse cord “C”, thereby effectively securing the cover 10 to the mouse 15 during use.

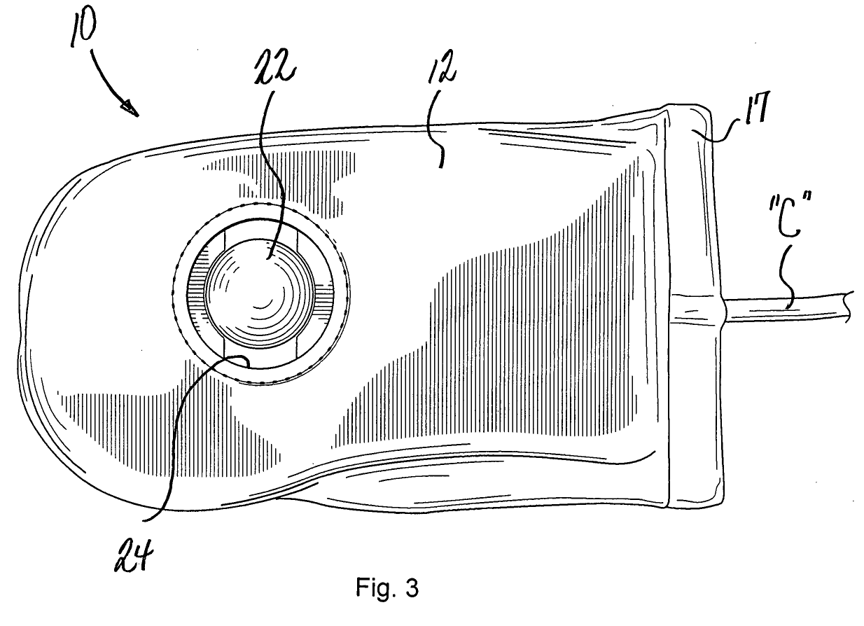

Referring to FIGS. 2 and 3, the mouse cover 10 is especially applicable for use with the computer mouse 15, as shown, including a hard outer shell 21 and rolling mouse ball 22. The mouse ball 22 located on an underside of the shell 21 engages a supporting surface, e.g., a mouse pad, and is rolled about by a user manipulating the mouse 15 in order to move the curser on the computer screen. To accommodate operation of the mouse ball 22, the bottom panel 12 of the cover 10 defines a circular ball hole 24 through which the ball 22 projects from the cover 10 and onto the mouse pad. A pressure-sensitive adhesive may be applied to an inside circumferential margin of the ball hole 24 to maintain the ball hole 24 in proper alignment with the mouse ball 22.

According to one embodiment, the top panel 11 of the cover 10 is constructed of a soft, absorbent or moisture-wicking fabric which serves to quickly move moisture away from the hand of the mouse user. Preferably, both the top and bottom panels 11, 12 are formed of a fabric comprising hydrophilic fibers, such as cotton, and/or other fibers including polyester and nylon, and/or elastic yarns, such as Spandex®. The elastic yarns may be used to tighten the fit of the cover 10 over the computer mouse 15. Alternatively, the bottom panel 12 may be formed of a non-absorbent, relatively slick material intended to promote sliding movement of the computer mouse 15 over the mouse pad (not shown). In yet another embodiment, the bottom panel 12 may comprise only an elastic strap or band designed to properly locate the top panel 11 in position over the top of the mouse 15.

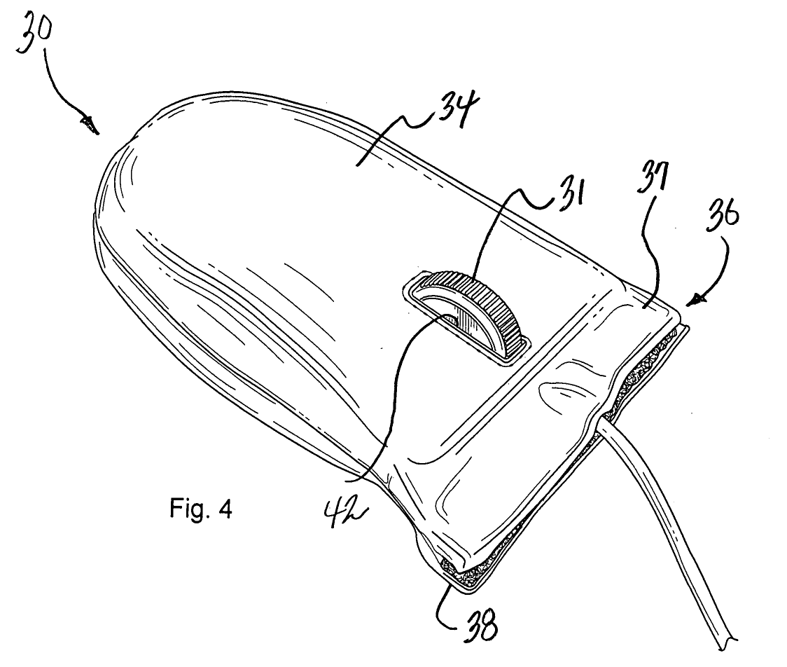

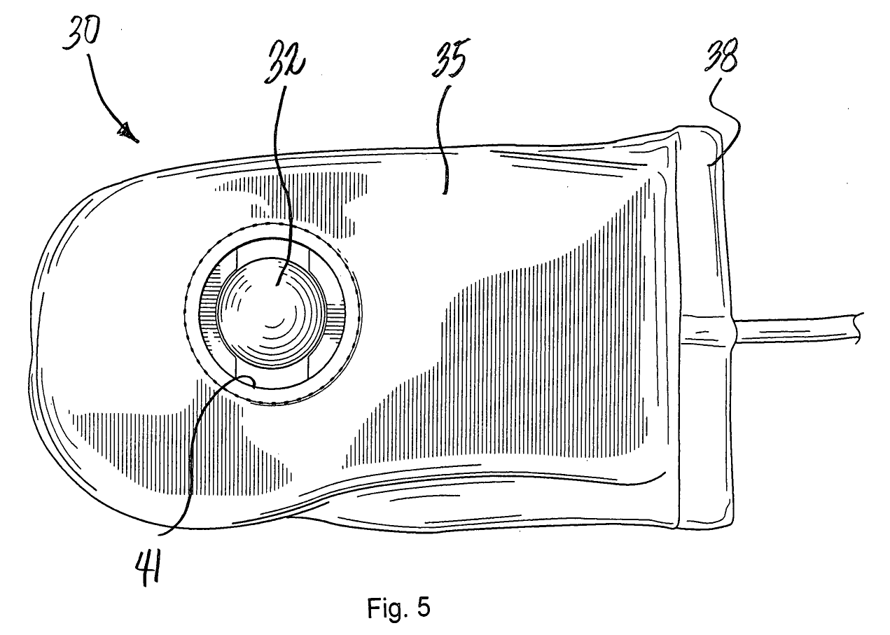

A further embodiment of a mouse cover 30 according to the present invention is illustrated in FIGS. 4 and 5. The mouse cover 30 is applicable for use with a standard computer mouse including a hard outer shell, scroll wheel, and rolling mouse ball—the scroll wheel 31 and mouse ball 32 being shown in FIGS. 4 and 5, respectively. The mouse cover 30 is constructed of opposing fabric panels 34 and 35 joined together along respective sides and forming an end opening 36 through which the computer mouse is inserted. First and second closure flaps 37 and 38 are formed with the panels 34, 35 at the end opening 36, and have mating fasteners which cooperate to close the end opening 36 and substantially encase the mouse inside the cover 30. To accommodate operation of the mouse ball 32, the bottom panel 35 of the cover 30 defines a circular ball hole 41 through which the ball 32 projects from the cover 30 and onto the mouse pad (not shown). Likewise, the top panel 34 defines a wheel hole 42 designed to accommodate access to the scroll wheel 31.

A computer mouse cover is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

1. A cover for use on a computer mouse having an outer shell and a mouse ball projecting from the shell, said cover comprising:
(a) top and bottom panels joined together along respective sides and forming an end opening adapted for receiving the computer mouse inside said cover; and
(b) said bottom panel defining a ball hole for accommodating passage of the mouse ball through said cover and onto a supporting surface.

2. A mouse cover according to claim 1, and comprising means for substantially closing said end opening, such that the computer mouse is substantially encased within said cover.

3. A mouse cover according to claim 2, and comprising first and second closure flaps formed with respective top and bottom panels at said end opening.

4. A mouse cover according to claim 3, wherein said means for closing comprises first and second complementary fasteners located on respective closure flaps.

5. A mouse cover according to claim 4, wherein said first and second fasteners comprise respective hook and loop fastener strips extending laterally at the end opening from one side of said cover to the other.

6. A mouse cover according to claim 1, wherein said top panel defines a wheel hole adapted for accommodating access to a scroll wheel located on the computer mouse.

7. A mouse cover according to claim 1, wherein said top and bottom panels are constructed of a fabric comprising fibers selected from the group consisting of polyester, cotton, and nylon.

8. A cover for use on a computer mouse having an outer shell, a mouse ball projecting from a bottom of the shell, and a scroll wheel projecting from a top of the shell for access by a user, said cover comprising:
(a) top and bottom panels joined together along respective sides and forming an end opening adapted for receiving the computer mouse inside said cover, and said top and bottom panels further comprising means for substantially closing said end opening;
(b) said top panel defining a wheel hole for accommodating access to the scroll wheel through said cover;
(c) said bottom panel defining a ball hole for accommodating passage of the mouse ball through said cover and onto a supporting surface; and
(d) said top and bottom panels being constructed of a fabric adapted for moving moisture away from a hand of the user.

9. A mouse cover according to claim 8, and comprising first and second closure flaps formed with respective top and bottom panels at said end opening.

10. A mouse cover according to claim 9, wherein said means for closing comprises first and second complementary fasteners located at respective closure flaps.

11. A mouse cover according to claim 10, wherein said first and second fasteners comprise respective hook and loop fastener strips extending laterally at the end opening from one side of said cover to the other.

12. A mouse cover according to claim 8, wherein said fabric comprises hydrophillic fibers.
